(19) United States
(12) Patent Application Publication
(10) Pub. No.: US 2013/0194093 A1
(43) Pub. Date: Aug. 1, 2013

(54) Personnel Warnings for Hazards

(71) Applicant: Michael Rakijas, Yorba Linda, CA (US)

(72) Inventor: Michael Rakijas, Yorba Linda, CA (US)

(73) Assignee: RAYTHEON COMPANY, Waltham, MA (US)

(21) Appl. No.: 13/363,503

(22) Filed: Feb. 1, 2012

(51) Int. Cl. G08B 1/08

(52) U.S. Cl. 340/539.13

(57) ABSTRACT

A system for notifying a user of a hazard, the system comprising a warning processor operative to receive data associated with a probable region affected by the hazard, and send a message including the data associated with the probable region affected by the hazard to a user device.

### BACKGROUND

The present invention relates to personnel warning systems, and more specifically, to personnel warning systems for hazards.

Hazards may include, natural hazards, industrial hazards, areas of social unrest, or fire attacks during a conflict.

Previous warning systems have been used to sound an audible alarm in an area proximate to the estimated position of the hazard to warn personnel of the danger.

### SUMMARY

According to one embodiment of the present invention, a method for notifying a user of hazard with a user device includes receiving a message in the user device, the message including data associated with a probable region affected by the hazard, determining a position of the user device, determining whether the position of the user device is within a defined notification region corresponding to the probable region affected by the hazard, defining a recommended direction of travel for the user responsive to determining that the position of user device is within the defined notification region, and outputting a notification including the recommended direction of travel with the user device to a user responsive to determining that the position of user device is within the defined notification region.

According to another embodiment of the present invention, a system for notifying a user of a hazard, the system comprising a warning processor operative to receive data associated with a probable region affected by the hazard, and send a message including the data associated with the probable region affected by the hazard to a user device.

According to yet another embodiment of the present invention, a user device for notifying a user of a hazard, includes a position determining portion operative to determine a geographic position of the user device and a processor portion operative to receive a message including data associated with a probable region affected by the hazard and output a notification to the user that includes a recommended direction of travel for the user responsive to determining that the user device is positioned in a notification region associated with the probable region affected by the hazard.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of an exemplary embodiment of a warning system.

FIG. 2 illustrates a plurality of user devices and exemplary notification regions.

FIG. 3 illustrates a plurality of user devices and exemplary notification regions.

FIG. 4 illustrates a block diagram of an exemplary method of operation of the system of FIG. 1.

FIG. 5 illustrates a tangent line and a recommended movement line.

FIG. 6 illustrates an exemplary embodiment of a graphical output of a user device.

### DETAILED DESCRIPTION

As discussed above, previous personnel warning systems use sensors to calculate an estimated hazard region for incoming hazards. Hazards may include any type of hazard such as, for example, natural hazards such as earthquakes, tornadoes, forest fires or hurricanes. Chemical, biological, or radiological agents may also present hazards. In a theater in conflict, personnel may be in danger from potential incoming munitions that may be detected by a sensor system.

The embodiments described below illustrate an exemplary system and method for providing hazard warnings for users in a probable region of impact, such region a sensed monition should impact. The embodiments described may be applied to any type of hazard, for example, natural phenomena such as tornados or fires may be detected by sensors and a probable hazardous region (i.e., region of impact or region affected by the hazard) may be defined in a similar manner as the a region of impact of the munitions. Thus, the methods and systems described below may be used to provide warnings and instructions to users via user devices for any type of hazard that may affect a geographical area, once the hazard is detected or predicted.

In this regard, hazard warning systems such as incoming munitions warning systems (or community disaster warning systems) determine whether the estimated point of impact was within a particular geographic area or zone, the systems may alert personnel in the zone by sounding an audible alarm. The audible alarm may be heard in a relatively large zone by a number of personnel who may be out of the danger areas presented by the incoming hazard. Such a system has limited effectiveness, since personnel tend to become complacent after repeatedly hearing the audible alarm while not being personally within a danger area presented by a particular incoming hazard. Further, even if personnel are sensitive to the audible alarm, such a warning fails to offer the personnel any indication of how an individual should react to the alarm. Thus, a warning system that may warn individual personnel who are presently in a danger area presented by an incoming hazard, and in some embodiments, provide individuals with additional information regarding the incoming munition and how an individual should act once they receive the warning is desired.

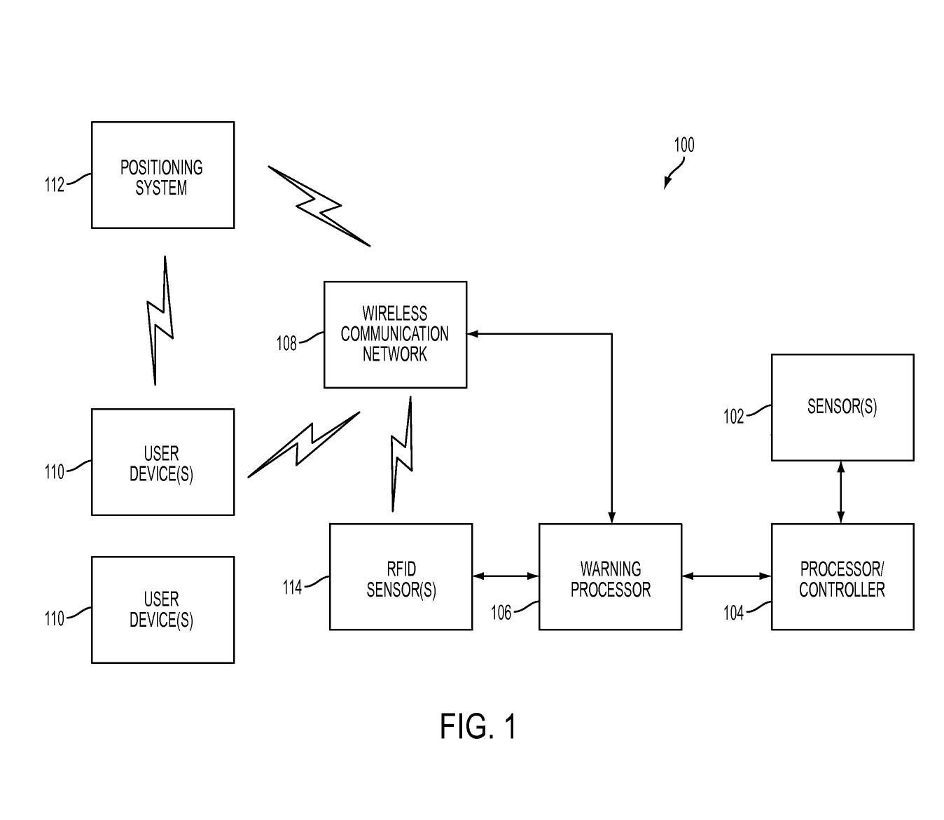

FIG. 1 illustrates a block diagram of an exemplary embodiment of a warning system 100. In this regard, the system 100 includes a sensor portion 102 that may include any number or type of sensor systems such as, for example, radar, laser, imaging, inferred, thermal, or acoustic sensor systems that may be used to detect and determine a trajectory of an incoming munition (or other hazard such as weather phenomena, fires, etc.), and in some embodiments a time of impact with the ground for the incoming munition. The sensor portion 102 is communicatively connected to a processor or controller portion 104 that is operative to control the sensor portion 102 and receive data from the sensor portion 102. The sensor portion 102 may include any number or type of sensor system or array of sensor systems operative to detect incoming munitions. The controller 104 is operative to determine trajectories of munitions and may calculate estimated geographic positions of impact of the munitions, and the estimated time of impact of the munition. The controller 104 is communicatively connected to a warning processor 106 that receives data, such as for example the estimated geographic positions of impact of the munitions. The warning processor 106 is communicatively connected to user devices 110 via a wireless communication network 108 that may include for example, a cellular data network or telephonic network, or another type of wireless communication network that is operative to send data to and from user devices 110. The user devices 110 may include, for example, mobile telephones, smartphones, personal computing devices, or any other type of portable user device that includes a processor and is capable of receiving data wirelessly. In the illustrated embodiment, the user devices 110 include positioning features such as, for example, global positioning system (GPS) receivers that are operative to receive GPS signals from the positioning system 112 and determine a geographic position of the user device 110.

Though the illustrated embodiment describes sensor systems that may detect a hazard, alternate embodiments may include the manual input of a point of impact or the definition of a hazard or notification region by the system following the input of data by an administrative user. For example, the location of a chemical spill may be reported to the administrative user, and the user may enter the location of the spill and other data such as wind speed and direction into the system to automatically or manually define the point or region of impact. Once the region has been defined, warnings may be sent to user devices using similar methods as described below.

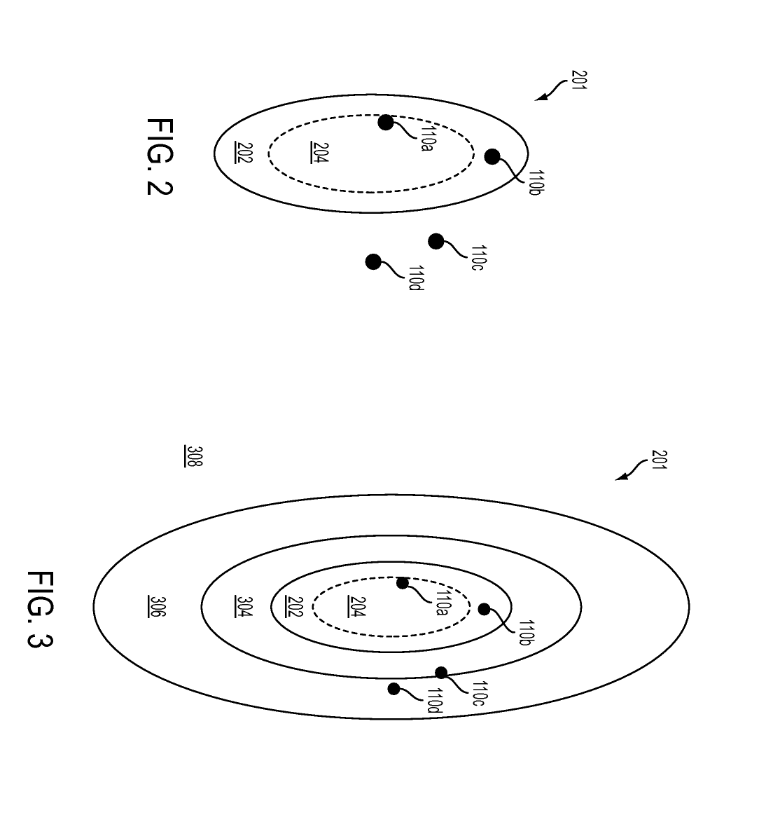

The operation of the system 100 will be described in further detail below. In this regard, FIG. 2 illustrates a plurality of user devices 110a-d represented by points and notification regions 201 that includes a danger region 202. The illustrated embodiment includes an elliptical region, however, in alternate embodiments, the danger region 202 (or any other regions of interest) may be represented by any other type of geometric shape. The danger region 202 represents an area of probable impact of the incoming munition (represented by the area 204) and an additional region outside of the area of probable impact 204 that may be affected by an explosion of the munition (i.e., personnel in the danger region 202 may be injured by the impact of the munition, concussion from an explosion of the munition, and/or shrapnel resulting from an explosion of the munition.) The size of the area of probable impact 204 may be determined by a number of factors, such as, for example, the quality of the data received from the sensor portion 102 (of FIG. 1) and thresholds for probability (e.g., a certainty threshold for defining the area of probable impact where the area becomes larger as the certainty threshold is increased). The size of the danger region 202 may be determined by other factors that may be set by a system administrator. For example, the threat of different sized munitions in a particular theater may be evaluated and used to define the size of the danger region 202 such that if relatively small munitions are expected, the danger area may be smaller as opposed to a theater where large munitions are expected, which may result in a larger danger area. Other systems may have the capability to determine a size or type of incoming munition dynamically, and thus may adjust the size of the danger region 202 to correspond to a particular sensed threat.

In operation, once the area of probable impact 204 has been determined by the system 100, a signal or communication may be sent via the wireless network 112 to the user devices 110. The user devices 110 may then determine whether the user device 110 (and by extension the user) is geographically located within the danger region 202. If the user device determines 110 determines that the user device 110 is indeed within the danger region 202, the user device may output a warning indication to the user. The warning indication, may include for example, any audio, visual, tactual, or vibratory indication that is operative to indicate to the user that the user is located in the danger region 202. With such a warning, the user may take appropriate action to mitigate the danger of the incoming ordinance such as, for example, positioning themselves behind protective cover. In this regard, in FIG. 2, the user devices 110a and 110b are located in the danger region 202, and thus would output a warning message, while the user devices 110c and 110d are not located within the danger region 202, and thus would not output a warning message to the user.

FIG. 2 illustrates one possible example of a region that may be defined for a particular warning. However, the system 100 is not necessarily limited to including only one region associated with a particular incoming munition, and may be used to define any number of associated regions. FIG. 3 illustrates an alternate embodiment of a set of regions that have been defined by the system 100. In this regard, the danger region 202 and area of probable impact 204 as described above are shown. An alert region 304 is shown surrounding the danger region 202. The alert region 304 may be defined as a region where personnel may not be in as severe danger as the danger region 202, but should still take actions to mitigate the risks from the incoming ordinance. A warning region 306 may also be defined that surrounds the alert region 304. The warning region 306 may be used to warn personnel within the warning region 306 that ordinance is predicted to impact in the vicinity, but such a warning indication may not instruct or compel an individual to take a particular risk mitigation action. Such a warning may be useful for notifying personnel in the warning region 306 to take a responsive action such as, for example, preparing to respond to assist casualties that may have resulted from the incoming ordinance. An activity region 308 may be defined outside of the warning region 306, and may be used to indicate to all personnel in the activity region, or in some instances, particular personnel, such as medical or safety personnel that there is fire activity in the activity region 308.

Though the illustrated embodiments of FIGS. 2 and 3 have shown examples of various regions that may be defined by the system 100 and corresponding or associated warnings that may be sent to user devices 110 in the region, it is understood that the exemplary embodiments described herein are not limited to the regions and zones illustrated and may include any number of regions of any size or shape having any associated or corresponding warning messages. The regions described above may be collectively or individually referred to as notification regions 201, where one or more notification regions 201 may be associated with a particular incoming munition, and different notification regions 201 may be associated with particular user notification messages or instructions.

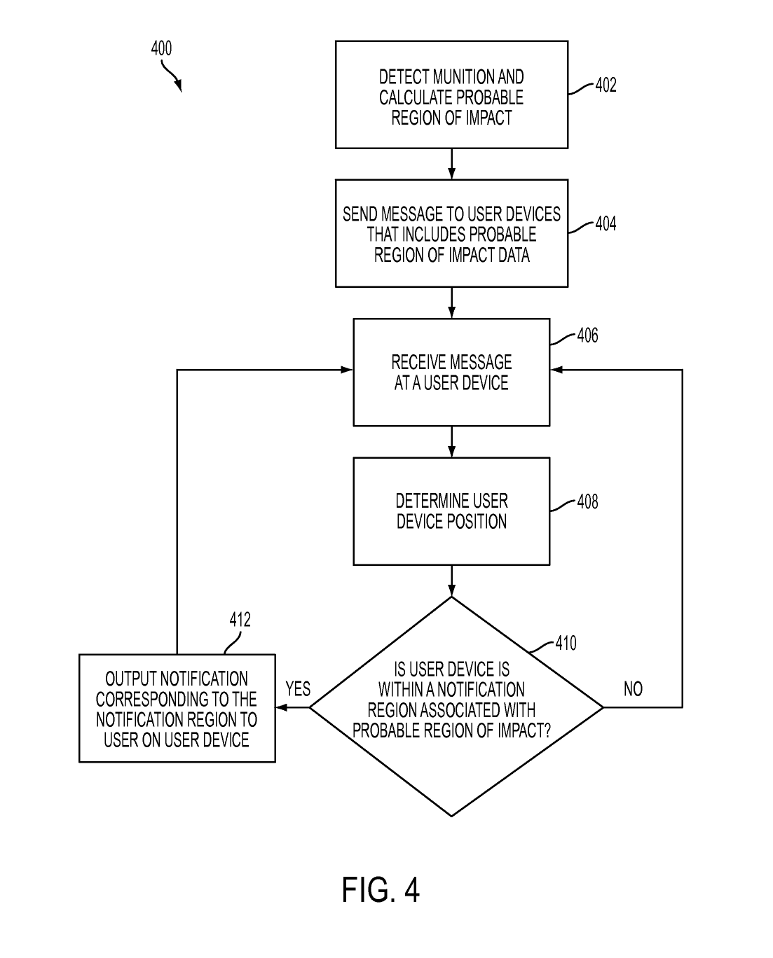

FIG. 4 illustrates a block diagram of an exemplary method 400 of operation of the system 100 (of FIG. 1). In this regard, block 402 a munition is detected by the sensors 102 and the processor 104 calculates a probable region of impact. The probable region of impact may include, for example a geographical position or a geographical region such as, for example, a region similar to the region 204 (of FIG. 2) The processor 104 outputs the probable region of impact to the warning processor 106. The warning processor 106 sends a message to the user devices 110 via the wireless communication network 108 that includes probable region of impact data in block 404. In block 406, the message is received by one or more user devices 110. In block 408, the user device 110 determines the geographic position of the user device 110 (e.g., by using the positioning system 112 and positioning hardware and software of the user device 110). Once the position of the user device 110 is determined, in decision block 410, the user device 110 determines whether the user device 110 is within a notification region 201 associated with the probable region of impact received in the message. If the user device 110 is within a notification region, a notification is output to the user on the user device 110 in block 412 that is associated with the particular notification region corresponding to the location of the user device 110. If the user device is not within a notification region 201, then the user device 110 may not output a notification. The output notification may include any audio, visual, textual, non-textual, tactile, or vibratory indicator operative to notify the user that the user is located in a particular notification region 201.

The message received by the user device 110 may include a variety of data. In an exemplary embodiment, the message may include a geographic position such as, for example, latitudinal and longitudinal coordinates and an estimated time of impact. In such an embodiment, the user device 110 may receive the coordinates in the message and define one or more notification regions similar to the regions described above in FIGS. 2 and 3. The regions may be defined using, for example, geometric calculations that define the regions, and particular notifications that are associated with each of the notification regions may also be associated with each of the defined notification regions 201. The definitions of the regions may be defined by the user or a system administrator using a user interface on the user device 110.

Alternatively, the warning processor 106 may define one or more of the notification regions 201, and the message may include data that defines the notification regions 201 that are associated with the incoming ordinance. In such an alternate embodiment, the user device 110 may merely determine whether the position of the user device 110 is within one of the received notification regions and output a corresponding notification message as described above.

In other embodiments, the warning processor 106 may detect the position of the user device 110 using other sensor devices such as, for example a radio frequency identifier (RFID) system. In such a system, the user device 110 may include an RFID portion that is operative to indicate either the position of the user device 110 as determined by the user device 110, or merely an identifier of the user device 110. The position of the user device 110 may be determined, for example, by an RFID sensor array 114 (of FIG. 1) that receives a signal indicative of the identification of the user device 110, and the approximate position of the user device 110 may be determined by associating the locations of portions of the RFID sensor array with the received signals from the user device. In operation, once the warning processor 106 determines the location of the user device 110, and defines a notification region 201 (of FIG. 2), the warning processor 106 may determine whether the user device 110 is within a defined notification region 201, and send general or unique messages (i.e., messages with recommended movement lines 503, described below, or other information) to the specific user device if the position of the user device 110 is within the notification region 201.

In an alternate embodiment, the user device 110 may send messages to the warning processor 106 that include the position of the user device 110 and in some embodiments an identifier of the user device 110. Such messages may be sent in response to a periodic query sent by the warning processor 106, or sent in response to a query sent by the warning processor 106 when incoming ordinance is detected by the warning processor 106. Alternatively, the user device 110 may send periodic messages to the warning processor 106 that correspond to a time interval. In yet another embodiment, the user device 110 may send a message to the warning processor 106 responsive to a change in position of the user device 110. For example, if the user device 110 determines that the position of the user device 110 has changed from the last reported position sent to the warning processor 106, the user device 110 may send an update message to the warning processor 106 with the position of the user device 110 and the identifier of the user device 110. In exemplary operation, once the warning processor 106 determines or receives the location of the user device 110, and defines a notification region 201 (of FIG. 2), the warning processor 106 may determine whether the user device 110 is within a defined notification region 201, and send general or unique messages (i.e., messages with recommended movement lines 503, described below, or other information) to the specific user device if the position of the user device 110 is within the notification region 201.

In some embodiments, the system 100 may have features that allow the system 100 to identify a particular type of incoming ordinance and vary the size or shape of the notification regions depending on the type of identified ordinance. For example, if the incoming ordinance is particularly large, the notification regions may be larger, while a smaller type of incoming ordinance may result in smaller notification regions.

Some users may desire to receive messages indicating the incoming ordinance regardless of the location of the users. For example, medical personnel, or leadership personnel may desire to be notified of any incoming ordinance regardless of the position of the users relative to the probable region of impact. Such users may, in some embodiments, set the user device to provide additional or more general notification messages if desired.

The embodiments described above provide a method and system for warning personnel that the person is within a particular region relative to a probable region of impact. The notifications may provide a user with general instructions that correspond to the proximity of the user device 110 to the probable region of impact. Thus, if a user is notified that they are within the danger region 202 (of FIG. 2) the user may take immediate cover to mitigate the dangers of the incoming ordinance, while if the user is in another region, such as an activity region 308, the user may merely note the activity, and may not need to take any mitigating actions. Though such illustrated embodiments are useful, alternate exemplary embodiments may provide additional information or instructions that may be used by the user to improve the safety of users.

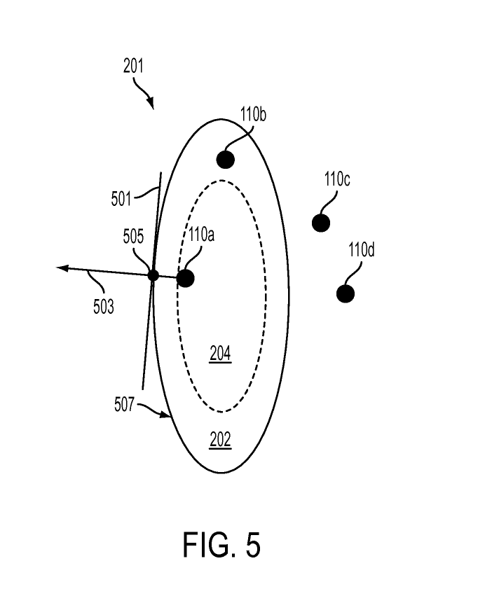

In this regard, FIG. 5 is similar to FIG. 2 described above, and includes a tangent line 501 and a recommended movement line 503. The tangent line 501 is a line tangent to a point 505 defined by the outer edge 507 of the danger region 202 that is closest to the user device 110a. The recommended movement line 503 is orthogonal to the tangent line 501 and includes the point 505. The movement line 503 extends from the geographic position of the user device 110a and indicates a direction of recommended movement that the user may take to move away from or out of the danger region 202 using the shortest path. In operation, the user device 110a may output, for example, a visual or textual indicator that corresponds to the recommended movement line 503 or an approximation of the recommended movement line 503 (e.g., output corresponding cardinal and/or ordinal directions to the user). Though the illustrated exemplary method of FIG. 5 includes one method for defining the direction of recommended movement, any other method may be used such as, for example, defining a vector from the position of the user device 110a to the point 505 or another desired point on the danger region 202 boundary.

Though the illustrated embodiment shows an elliptically shaped danger region 202, if alternate geometric shapes are used to define the danger region 202, other mathematical and geometric methods may be used to define the recommended movement line 503. For example, if the danger region 202 is defined by a rectangular shape, the nearest edge of the shape, not including any angled corners of the shape may be used to define the tangent line 501. (E.g., The closest linear edge of the danger region to the position of the user device 110a may be defined as the tangent line 501.) Thus, any geometric shape may be used to define the danger region 202, and any relevant method or scheme may be used to define the recommended movement line 503 that corresponds appropriately to the geometric shape of the danger region 202.

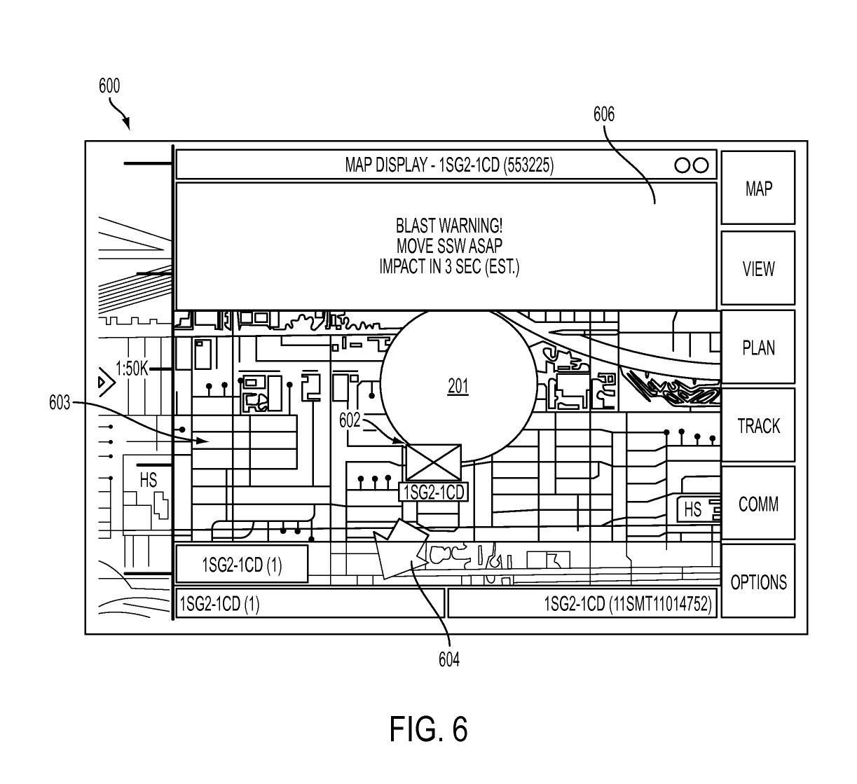

FIG. 6 illustrates an exemplary embodiment of a graphical output 600 of a user device 110. The output 600 includes textual and non-textual elements including a position of the user device 602 arranged on a graphical map 603. A notification area 201 arranged on the map 603, and a recommended movement direction indicated by the arrow 604. A textual indicator 606 may be displayed that indicates a type of notification (e.g., “blast warning”) a time to impact, and instructions for action.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for notifying a user of hazard with a user device, the method comprising:
receiving a message in the user device, the message including data associated with a probable region affected by the hazard;
determining a position of the user device;
determining whether the position of the user device is within a defined notification region corresponding to the probable region affected by the hazard;
defining a recommended direction of travel for the user responsive to determining that the position of user device is within the defined notification region; and
outputting a notification including the recommended direction of travel with the user device to a user responsive to determining that the position of user device is within the defined notification region.

2. The method of claim 1, wherein the message includes data defining the defined notification region.

3. The method of claim 1, further comprising defining the notification region responsive to receiving the data associated with the probable region affected by the hazard.

4. The method of claim 1, wherein the message includes an estimated time the probable region will be affected by the hazard.

5. The method of claim 4, wherein the output notification includes the estimated time the probable region will be affected by the hazard.

6. The method of claim 1, wherein the output notification includes an indication of the position of the user device relative to the defined notification region.

7. The method of claim 1, wherein the output notification includes a textual instruction associated with the defined notification region.

8. The method of claim 1, wherein method further includes defining a recommended action for the user responsive to determining that the position of user device is within the defined notification region, and the output notification includes the recommended action.

9. A system for notifying a user of a hazard, the system comprising a warning processor operative to receive data associated with a probable region affected by the hazard, and send a message including the data associated with the probable region affected by the hazard to a user device.

10. The system of claim 9, wherein the system further includes a sensor communicatively connected to the warning processor, the sensor operative to detect the hazard and output data associated with the detected hazard.

11. The system of claim 9, wherein the message includes an estimated time the hazard will reach the region of impact.

12. The system of claim 9, wherein the warning processor is further operative to define a notification region corresponding to the probable region affected by the hazard, and the message includes data defining the notification region.

13. A user device for notifying a user of a hazard, the user device comprising:
a position determining portion operative to determine a geographic position of the user device; and
a processor portion operative to receive a message including data associated with a probable region affected by the hazard and output a notification to the user that includes a recommended direction of travel for the user responsive to determining that the user device is positioned in a notification region associated with the probable region affected by the hazard.

14. The device of claim 13, wherein the processor portion is operative to determine a position of the user device, determine whether the position of the user device is within a defined notification region corresponding to the probable region affected by the hazard, and output the notification.

15. The device of claim 13, wherein the message includes data defining the defined notification region.

16. The device of claim 13, wherein the device is further operative to define the notification region responsive to receiving the data associated with the probable region affected by the hazard.

17. The device of claim 13, wherein the message includes an estimated time of impact of the hazard in the probable region affected by the hazard, and the output notification includes the estimated time of impact of the hazard in the probable region affected by the hazard.

18. The device of claim 13, wherein the output notification includes an indication of the position of the user device relative to the defined notification region.

19. The device of claim 13, wherein the output notification includes a textual instruction associated with the defined notification region.

20. The device of claim 13, wherein device is further operative to define a recommended action for the user responsive to determining that the position of user device is within the defined notification region, and the output notification includes the recommended action.
